(19) United States
(12) Patent Application Publication
(10) Pub. No.: US 2012/0173578 A1
(43) Pub. Date: Jul. 5, 2012

(54) METHOD AND APPARATUS FOR MANAGING E-BOOK CONTENTS

(75) Inventor: Cheol-Ho Cheong, Seoul (KR)

(73) Assignee: SAMSUNG ELECTRONICS CO., LTD., SUWON-SI (KR)

(21) Appl. No.: 13/341,135

(22) Filed: Dec. 30, 2011

(30) Foreign Application Priority Data
Jan. 3, 2011 (KR) 10-2011-0000234

(51) Int. Cl. G06F 17/30

(52) U.S. Cl. 707/780; 707/E17.014

(57) ABSTRACT

A method and apparatus for managing e-book contents. A method for registering content information includes performing a content path setting process to set a path for an access to contents. The method also includes performing a content information setting process to acquire information related to the contents. The method further includes performing a content database searching process to search whether there is a database record similar to the information. The method still further includes performing a content classification code setting process to set a content classification code for the contents if the search result is that the contents are not registered or are stored as an unclassified value. The method also includes performing a content database updating process to update the content classification code in a content database.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Jan. 3, 2011 and assigned Serial No. 10-2011-0000234, the contents of which are incorporated herein by reference.

### TECHNICAL FIELD OF THE INVENTION

The present disclosure relates generally to electronic books (e-books).

### BACKGROUND OF THE INVENTION

A conventional e-book provides a service for inputting a memo or annotation (footnote) of a user and determining the same in a relevant page, or transmitting the memo or annotation to other device and showing it in a relevant e-book page. Also, the service allows the user to search a desired keyword or related on-line contents.

However, these techniques are possible only in the relevant e-book contents, thereby failing to providing or managing cross references between multiple e-books in an integrated manner.

Also, the conventional e-book does not consider integrated management of multimedia contents (e.g., videos), documents, and book information, thus failing to provide extensive services for users.

### SUMMARY OF THE INVENTION

To address the above-discussed deficiencies of the prior art, it is a primary object to provide at least the advantages below, Accordingly, an object of the present disclosure is to provide a method and apparatus for managing e-book contents.

Another object of the present disclosure is to provide a method and apparatus for providing a convenience for a user in managing contents by managing increasing contents and the details and subjects of the contents.

Another object of the present disclosure is to provide a method and apparatus for analyzing keywords, phrases, person names, place names, titles, indexes, footnotes, endnotes, references, copyright information, notes and memos of users from various contents such as books, documents, images, videos, sounds and captions owned by or determined by users, drawing items from these, and integrating location information of item-related contents, category information of each item, and detailed information of each item into a database.

Another object of the present disclosure is to provide a method and apparatus for performing classification and management based on content details, searching and determining items through a user interface, and managing the same in an integrated manner.

Another object of the present disclosure is to provide a method and apparatus for searching contents read or owned by users, memos recorded by users, or desired on-line contents, and preferentially searching information of fields having a high correlation with respect to contents that are being determined.

Another object of the present disclosure is to provide a method and apparatus for constructing and outputting user reference information related to information, and, when a user creates or determines a document, determining a reference list related to a relevant item and indicating that it is a reference.

Another object of the present disclosure is to provide a method and apparatus for systematically managing and searching not only books and documents but also multimedia contents, memos and footnotes by allocating a content classification code for contents owned by users.

According to an aspect of the present disclosure, a method for registering content information is provided. The method includes performing a content path setting process to set a path for an access to contents. The method also includes performing a content information setting process to acquire information related to the contents. The method further includes performing a content database searching process to search whether there is a database record similar to the information. The method still further includes performing a content classification code setting process to set a content classification code for the contents if the search result is that the contents are not registered or are stored as an unclassified value. The method also includes performing a content database updating process to update the content classification code in a content database.

According to another aspect of the present disclosure, a method for registering content information is provided. The method includes performing a basic content information setting process to set basic information of contents. The method also includes performing a content database determining process to determine whether the contents are unregistered or unclassified. The method further includes performing a content information setting process to set content information of the contents for content analysis if the contents are unregistered or unclassified. The method still further includes performing a content database redetermining process to redetermine whether the contents are unregistered or unclassified, by redetermining a content database by using the content information and the basic content information. The method also includes performing a content classification code setting process to set a content classification code for the contents if the redetermination result is that the contents are unregistered or unclassified. The method further includes performing a content database updating process to update the content classification code in the content database.

According to another aspect of the present disclosure, a method for registering content-related information is provided. The method includes performing a related information item setting process to set items of related information for classification of the related information. The method also includes performing a content classification code setting process to set a content classification code by analyzing tag information of contents or by using a classification code allocated to contents where related information is located. The method further includes performing an in-content location information setting process to determine whether attributes including an in-content location and range are necessary for output when determining an item and content corresponding to the content classification code. The method still further includes performing an additional information setting process to determine whether additional information is inputted by a user input and to set the additional information when the additional information is inputted. The method also includes performing a related information updating process to update the related information if it is necessary to update information of a related information record.

According to another aspect of the present disclosure, a method for determining content-related items is provided. The method includes performing a related information setting process to set content-related information to be searched. The method also includes performing a related information list drawing process to draw a related information list from a related information database. The method further includes performing a related information arranging process to arrange related information according to a predetermined priority by using a content classification code. The method still further includes performing a reference list constructing process to construct a reference list by using the arranged related information, content information of a content database, and a user input. The method also includes outputting the constructed reference list.

According to another aspect of the present disclosure, an apparatus for registering content information is provided. The apparatus includes a content storing unit configured to set a path for an access to contents. The apparatus also includes a content information analyzing unit configured to acquire information related to the contents. The apparatus further includes a content database configured to search whether there is a database record similar to the information, and update a content classification code in a content database. The apparatus still further includes a content classifying unit configured to set the content classification code if the search result is that the contents are not registered or are stored as an unclassified value.

According to another aspect of the present disclosure, an apparatus for registering content information is provided. The apparatus includes a content information analyzing unit configured to set basic information of contents, and set content information of the contents for content analysis if the contents are unregistered or unclassified. The apparatus also includes a content database configured to determine whether the contents are unregistered or unclassified, re-determine whether the contents are unregistered or unclassified by using the content information and the basic content information, and update a content classification code in the content database. The apparatus further includes a content classifying unit configured to set the content classification code for the contents if the redetermination result is that the contents are unregistered or unclassified.

According to another aspect of the present disclosure, an apparatus for registering content-related information is provided. The apparatus includes a related information registering unit configured to set items of related information for classification of the related information. The apparatus also includes a content classifying unit configured to set a content classification code by analyzing tag information of contents or by using a classification code allocated to contents where related information is located. The apparatus further includes a content location analyzing unit configured to determine whether attributes including an in-content location and range are necessary for output when determining an item and content corresponding to the content classification code. The apparatus still further includes a related information database configured to update the related information if it is necessary to update information of a related information record.

According to another aspect of the present disclosure, an apparatus for determining content-related items is provided. The apparatus includes a user interface configured to set content-related information to be searched. The apparatus also includes a related information database configured to draw a related information list, and arrange related information according to a predetermined priority by using a content classification code. The apparatus further includes a reference list creating unit configured to construct a reference list by using the arranged related information, content information of a content database, and a user input. The apparatus still further includes a display unit configured to output the constructed reference list.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram illustrating a process for registering contents according to an embodiment of the present disclosure;

FIG. 2 is a flow diagram illustrating a process for registering contents according to another embodiment of the present disclosure;

FIG. 3 is a flow diagram illustrating a process for registering related information according to an embodiment of the present disclosure;

FIG. 4 is a flow diagram illustrating a process for registering new contents during the registration of related information according to an embodiment of the present disclosure;

FIG. 5 is a flow diagram illustrating a process for determining related information according to an embodiment of the present disclosure;

FIG. 6 is a block diagram of an apparatus according to an embodiment of the present disclosure;

FIG. 7 is a diagram illustrating a content database registration process according to an embodiment of the present disclosure; and

FIG. 8 is a diagram illustrating an example of related information input and reference information determine according to an embodiment of the present disclosure.

### DETAILED DESCRIPTION OF THE INVENTION

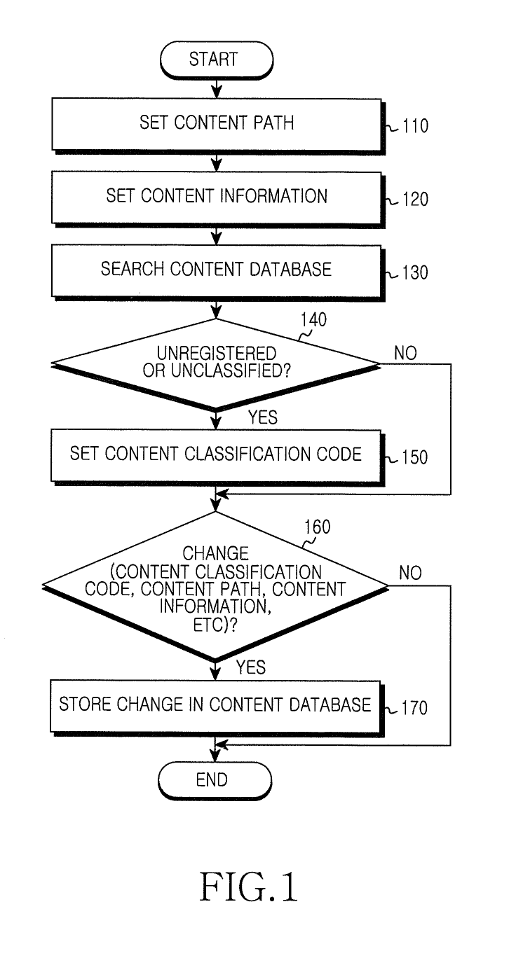

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

The present disclosure provides a method and apparatus for managing e-book contents and in particular, to a method and apparatus for allowing a user to easily search and register desired information from off-line and on-line electronic documents, memos, notes (or annotations) and contents authorized for the user, and to manage the same as a reference when creating a document.

In the present disclosure, examples of the contents include text documents that can be determined in electronic devices, script documents of XML formats, editable documents such as DOC, HWP and PDF, e-book documents, images, videos, sounds, caption files, lyric files, and Web contents.

In the present disclosure, an information registration process may be divided into a content information registration process and a related information registration process. Accordingly, information may be registered in a content database and a related information database to provide a service.

The content database is configured to store content classification codes, content types, physical location information, and content information of contents such as books, documents, sounds, videos and images, which may be defined as a kind of outline information of contents.

The related information database is configured to manage keywords, person names, subject words, titles, phrases, indexes, footnotes, endnotes, and memos in relation to contents, which may include desired related information titles and related content classification codes and may further include in-content location information, additional information, and reference information.

A content registering unit registers relevant information in the content database, and a related information registering unit registers relevant information in the related information database. In general, a related information registration process may be selectively performed after a content registration process is performed.

A content registration method includes a content path setting process, a content information setting process, and a content classification code setting process. Table 1 below shows an example of the content database created by the content registration method.

TABLE 1

| type | information | code | src |
|---|---|---|---|
| book | translation; lang: kr; org: | 291.13B [symbol] 54 | \\ebook\books\arthurCotterel_a_dictionary_of_world_mythology86.pdf |
| | eng; title: [symbol] | [symbol] 01 | |
| | [symbol] [symbol] [symbol] ; A | | |
| | Dictionary of World | | |
| | Mythology; author: [symbol] | | |
| | [symbol] eng: Arthur Cotterel; | | |
| | translator: Kacci editorial | | |
| | department; publish: Kacci | | |
| | GeulBang; Oxford | | |
| | University Press; | | |
| | YYMMDD: 960520; | | |
| | 19790000/19860000; | | |
| | ISBN: 8972910902 | | |
| document | title: Unsupervised clustering | 535.05DC652U01 | \\myPC\journal\c.cheong2008_ucacccicr.pdf |
| | approaches to color | | |
| | classification for color-based | | |
| | image code recognition; | | |
| | author: Cheolho Cheong, | | |
| | Gordon Bowman, Tack-Don | | |
| | Han; | | |
| | book: Applied Optics; | | |
| | volume: 47; issue 13; | | |
| | pp: 2326-2345; | | |
| | YYMMDD: 080428; | | |
| | doi: 10.1364/AO.47.002326 | | |
| | category: vision, color, visual | | |
| | optics; | | |
| | keywords: color, color | | |
| | classification, color-based | | |
| | image code recognition; | | |
| | ISSN: 00036935; | | |
| | download: YYMMDD: | | |
| | 100825; src: | | |
| | http://www.opticsinfobase.org/ | | |
| | viewmedia.cfm?uri= | | |
| | ao-47-13-2326&seq=0 | | |
| Music/ | title: Song for Dankun; artist: | 291.13SK31T03 | \\ebook\books\korea_mythology_t03.mp3 |
| Sound | Korea Mythology Research | | |
| | Center; album: Korean | | |
| | Mythology; year:; genre: | | |
| | folk; track: 3; description: | | |
| | record from Seoul, Korea; | | |
| | composer: Korea Mythology | | |
| | Research Center; | | |
| | copyright: SamsungMusic | | |
| | Co. ltd.; url: | | |
| | http://samsung.com/; | | |
| Video | title: ColorCode recognition; | 535.05VC01C01 | \\myPC\journal\c.cheong2008_ucacccicr.avi |
| | author: C. Cheong; duration: | | |
| | 1200000; resolution: | | |
| | 1200×760; codec: h.264; | | |
| | audio: mp3; tag: color, | | |
| | classification; | | |
| Caption | title: ColorCode recognition; | 535.05CC01C01 | \\myPC\journal\c.cheong2008_ucacccicr.smi |
| | author: C. Cheong; duration: | | |
| | 1200000; format: smi; | | |
| | tag: color, classification; | | |
| Image | title: Avatar status in India; | 291.13IW01A01 | \\myPC\image\www_namsan_com\hindu\india\avatar01.jpg |
| | resolution: 1920×1200; dpi: | | |
| | 96×96; bits: 24; artist: | | |
| | Westend61/Getty Images; | | |
| | location: GPSxxxxxxxxxxxx; | | |
| | description: Avatar image | | |
| | from hindu temple in India; | | |
| | created time: 090203; | | |
| | modified time: 100810; | | |
| | copyright: Namsan Inc.; | | |
| | http://www.namsan.com/ | | |
| | hindu/india/avatar01.jpg; | | |
| | download: 2010.08.24; | | |

As a simple example, the content registration method acquires unregistered new contents and registers the unregistered new contents in the database. The following is an embodiment where it is already known that content access and use are possible and the contents are not registered in the content database.

In an apparatus according to the present disclosure, when a content registration request is generated through an operation of storing, determining, copying, downloading, or correcting new contents, path information of the contents is set first. The content path is used as a means for accessing actual contents.

Devices accessible through the content path setting may be a single device, several devices connected in a wired/wireless manner, and/or contents on the Internet. Examples of the devices, which may be location information of contents, include PCs, notebook computers, work stations, electronic albums, portable phones, smart phones, tablet PCs, PMP, MP3, electronic dictionaries, TVs, settop boxes, DVD players, console games, cameras, e-books, USB memories, flash memories, and on-line accessible storage media. For CD, DVD and USB media, the physical storage location in a database may be meaningless. However, although not present in a relevant media reader, other information may be retained in databases for later detection.

If the information is flexible like a web page, it may be copied into a storage unit of a certain device, if possible. In this situation, an Internet address and a copy date may be stored in content information, and content path information may be retained as path information of a copy place. This is to present determine time information of relevant contents together with a reference list to be presented later.

For example, although a web page is currently absent on the Internet, the web page may be determined using location information of a certain device that is stored separately. Also, if the web page is used as a reference, objectivity may be secured by representing the web page together with an absent Internet address by using storage date information of the web page.

If the web page cannot be stored separately, it may also be possible to store only Internet address information. In Table 1, the second item represents a situation where an Internet address is included in content information and the content information also includes an address of contents that is accessible because it is currently stored.

Content information is set after completion of the content path setting. The content information means various information related to contents to be registered, which may be acquired using various means.

In general, basic information may be provided together when a content registration request is generated. Examples of the basic information include a content file name, a file extension, the content of a web site for downloading contents, and an additional file provided together with a content file.

For example, important information about relevant contents may be known from the name of a downloaded file. If the relevant contents are acquired by selecting one from a reference list in a web site, reference information, which is a linker of the relevant contents, is very useful.

The information may also include information input by a user interface. This information may be directly used. It may be searched by an information search engine, and information may be supplemented by the most suitable search result.

Another way to acquire content information is to acquire contents themselves. Recent contents themselves are structuralized, and they are mostly classified according to content type. The content type corresponds to content information, and it means the data type of contents. The content type may be defined as categories and groups for classifying contents according to their content and function.

Examples of the content type include books, sounds, images, videos, databases, and programs. If there is other content type necessary for a system or a function, it may be defined and used.

In general, the content type may be determined using file format information, header parsing, and configuration information in a file/folder. The file format may be determined by parsing file extension information and a file header part.

For example, if the format of a file extension is DOC, HWP, ePub, BeBB, AZW, PDF, PPT, XLS, TXT, or RTF, the file is a document file. If the format of a file extension is mp3, wma, ra, mid, pmd, or amr, the file is a music/sound file. If the format of a file extension is mp4, 3gp, wmv, divx, avi, rm, or rmvb, the file is a video file. If the format of a file extension is exe or com, the file is a program execution file. If the format of a file extension is png, tif, jpg, or bmp, the file is an image file.

However, if a file extension is DAT and it is used in various types such as databases and videos, the content thereof cannot be detected from the file extension. Therefore, it is necessary to parse a data part or a header part of the file to detect the content thereof.

Also, if a file extension is a compressed file format such as ZIP, rar, or alz, the content thereof cannot be detected from the file extension. Therefore, it is necessary to decompress a compressed file and parse/decode the file extension or the file to determine the content thereof.

Particularly, for an image format, it is necessary to make a determination not by an image type but by a document type.

For example, there is a situation where each page is scanned and it is included in one compressed file or one directory/folder. In this situation, the image is included in the compressed file or the folder, and file names are mostly constructed in a related and continuous manner such as imae01, image02, . . . , imageN. Thus, the relation between the file names collected in the compressed file or the folder may be analyzed, and the content type may be determined on the basis of the analysis result. That is, the file extension may be determined through the content type analysis and the content parsing. Also, direct designation may be made by a user interface.

In a content information detection process, a content type may be determined first, and content information may be detected and registered on the basis of the determination result. If the content type is determined first, it is easier to analyze and collect the content information.

For example, if the content type is document, information such as author, translator, editor, article title, book title, publisher, serial number, volume number, page, publication date, URL, appendix information, and barcode number corresponds to the content information.

If the content type is image, information such as GPS (location information), time information, image title, comments (image description, user comment), producer (artist), copyright information, subject words, photographing environment information (tags relating to picture-taking condition), related audio (sound) file name, and scene type corresponds to the content information.

If the content type is music, information such as performer, album title, composer, performance time, album image, equalizer information, creation time, genre, and detailed music information (description) corresponds to the content information.

If the content type is video, information such as play time, title, video information, music layer information, codec information, release information, and caption information corresponds to the content information.

As shown in Table 1, the content information may be managed on an item-by-item basis. This enables systematic management of a database, and enables various services such as a format change when a reference is provided later.

The content information may be recorded in the relevant contents, or may be provided through a title or a separate file added together with the relevant contents.

For example, XML, DOC, HWP, ePub, BeBB, AZW, PDF, and PPT files having a structuralized document format may include the detailed content information in a certain region of the file. An MP3 file may include content information in an ID3tag located at a heard part of the file. Likewise, a JPG file may include content file in exif information.

An example of a separate additional file provided is a separate file for video release information. Various information such as video resolution, encoder, and play time may be recorded in the separate file. Also, a video caption file and a music lyric file may correspond to the separate file.

Particularly, in the case of document/book contents widely used in e-book services, the last part and the front part including a book cover, a title page and a publication information page may be preferentially parsed, and keywords such as ‘title’, ‘author’, ‘translation’, ‘translator’, ‘publisher’ and ‘date’ may be searched to find content information adjacent thereto.

However, it may be difficult to determine this from in-content information. For example, if book contents include an image file, character regions may be found not in format information of the image file but in the image file. An optical character recognition (OCR) technique may be used to recognize characters. It may be determined whether the characters correspond to the content information. A search process may be performed if they correspond to the content information.

The content information may be acquired by various methods, and a search technique may be additionally used to acquire more detailed information.

For example, additional information may be acquired by an on-line database or web site search through content titles.

Also, the content information acquired by the above methods may be used to search for more accurate and detailed content information.

For example, if relevant site information (an on-line address such as URL, or e-library search code information such as ISBN) is included in a relevant file for the content information, the information may be used to easily acquire accurate and detailed content information from a library database or a publisher database.

If such contents are downloaded or copied, such information may also be automatically loaded and registered through a dedicated application.

If such an automatic input is difficult to perform, it may be inputted by a user interface.

If a user interface is used, a user may select and input all of the information; and if not, only some of the information may be added. Also, the above recognition method may be partially used.

For content registration, contents may be encoded by digital rights management (DRM) or may be compressed like a ZIP file. In this situation, the file may be decoded and decompressed prior to parsing.

When, the content information is acquired, it may be used to allocate content classification codes. The content classification codes may be classified according to content type. For example, a book classification code may be allocated.

Examples of the book classification code include a decimal classification, a non-decimal classification, and a caller number. One particular example of the decimal classification is Dewey Decimal Classification (DDC).

The DDC includes numeral units and has a hierarchical structure of main classes+divisions+sections+ . . . +subsections.

Recently, E-DDC (CD-ROM) is also used for content classification in an e-library (electronic library). Besides the DDC, there are Universal Decimal Classification (UDC), Korean DC (KDC), and Nippon DC (NDC).

Examples of the non-decimal classification include Expansive Classification (EC), Library of Congress Classification (LCC), Subject Classification (SC), Colon Classification (CC), and Bibliographic Classification (BC).

The caller number includes additional detailed information added together with a book classification system in a library, which may further include an author name, the first character of a product name, a publication year, a publisher, and a serial/volume number. One or more of the book classification codes may be used, but only some information of the book classification codes may be used for the sake of convenience.

The book classification code may be allocated by various methods. The best method may be to recognize a code classification number allocated in contents. For example, the book classification code may be embedded in a file specific field of an e-book format such as XML, DOC, HWP, ePub, BeBB, AZW, PDF, or PPT constituting e-book contents, and it may be read in and set automatically.

However, if it is a ZIP file or a BMP, or if it is difficult to embed a book classification code, the relevant book classification code may be allocated using content title, author, and publisher information through an on-line database.

In particular, if a classification table provided by a library or a publisher is used, this becomes easier. If there is a database created by other users, it may be searched for reference.

Book classification codes may be allocated by various other methods. For example, in the case of patent information, a relevant technical field may be analyzed on the basis of an IPC (international product code) allocated to a patent document. Then, suitable book classification codes may be searched, and the most suitable code may be estimated and allocated, which is a secondary estimation process.

In the case of multimedia, image, or sound files, content classification codes may be allocated by such a method. It is common to use a code classification system of E-DDC. However, it may be necessary to perform classification on a call number basis, and such classification numbers may be allocated on a file basis, not on a disk basis.

One or more content classification codes may be allocated. For example, books relating to Buddha may correspond to various classifications such as religion, mythology, and art history. One or more classification codes may be allocated according to the characteristics of the relevant books.

Content classification codes may be automatically allocated by the above methods, and such information may be inputted by a user interface. The user interface may be used to input category lists to select in the order of from division to section.

As an example of the structure of content classification codes, in the case of an English book ‘Snow Crash’ written by Neal Stephenson, 813.5BS836S01 may be allocated as a content classification code. In this example, it includes a DDC code ‘813.5’, ‘B’ representing a book, a code ‘S836’ representing an author (Stephenson), the first character ‘S’ of a book name (Snow Crash), and a serial number ‘01’.

As another example, a content classification code representing a movie ‘Avatar’ directed by James Cameron may be represented by 688.2VC10A01 that includes DDC code ‘688.2’+Video ‘V’+James Cameron ‘C10’+‘A01’ representing the first product starting with ‘A’. This classification code may be constructed in a different structure, if necessary.

The classified information may be updated through a network into a database, so that it may be shared between several users. Table 1 shows an example of the structure of a database for recording content types, content information, content classification codes, and location information thereof.

A related information registration process may be performed after the classified content types, content information and content classification codes are stored in the database together with the location information of the relevant contents.

The content types are also shown in Table 1. However, if the content type is included in the content classification code, it need not be stored as a separate item.

FIG. 1 is a flow diagram illustrating a process for registering contents according to an embodiment of the present disclosure.

Referring to FIG. 1, an apparatus according to an embodiment of the present disclosure sets a path for contents (block 110). Thereafter, the apparatus sets information from the contents (block 120), and performs a database search on the information (block 130).

That is, the apparatus searches registered information to consider whether relevant contents are registered and whether the components of the registered contents are valid.

If the contents are unregistered or unclassified (block 140), the apparatus sets a new content classification code (block 150). If a change is present therein (block 160), the apparatus stores the change in a database (block 170).

That is, for registration of the contents, it is necessary to determine whether content information is registered in a content database, and it may be necessary to update the content database.

Also, there may be a situation where the content information is very restrictive and it is difficult to allocate a content classification code. In this situation, a content category may be represented by ‘U’ or another mark may be used to allocate a content classification code, so that it may be considered when the content database can be updated later.

In FIG. 1, a characteristic feature is a content correction determination process. If the content information is unregistered or the code classification number is allocated as an unclassified category, the information may be newly registered, updated, or corrected in the content database.

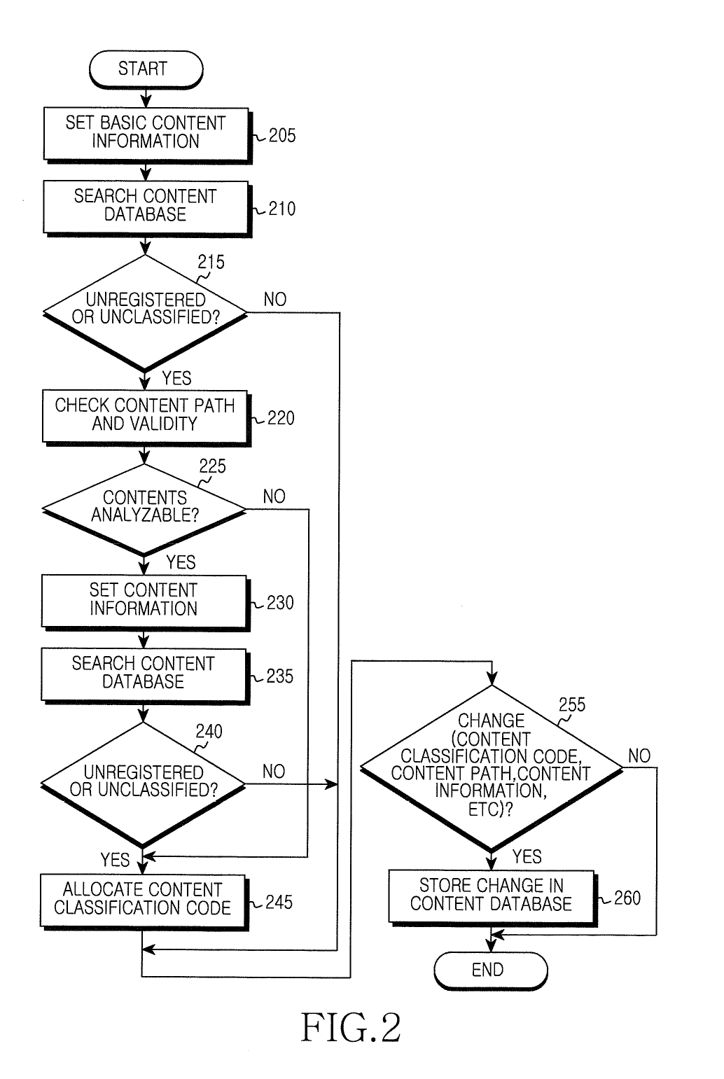

FIG. 2 is a flow diagram illustrating a process for registering contents according to another embodiment of the present disclosure.

Referring to FIG. 2, there may be situation where a content analysis is difficult or impossible in content registration and only limited content information is acquired. An example is a situation where content information is included in an endnote, footnote, or reference item in a document or a book.

In this situation, it is necessary to determine whether the contents can be acquired. If the contents are difficult to acquire, it may be necessary to register the contents by limited content information.

In FIG. 2, basic content information is information that can be provided at a content registration request. Examples of the basic content information include a file name, a content name, a linker, a phrase, and an URL address that can be acquired without analyzing a content file. It may be provided by a user interface.

When the basic content information is acquired, it may be used to search a content database to determine whether the contents are registered. If the registered information is useful, the basic content information may be used to update the database.

Alternatively, if the contents are unregistered or unclassified, content path information may be used to acquire the contents. If the path information is not useful, an attempt may be made to acquire the contents by search and purchase.

If content acquisition or analysis is difficult or impossible, the basic content information may be used to set a content classification code and update the database. Alternatively, if content acquisition or analysis is possible, it may be used to draw content information, and it may be used together with the basic content information to re-search the content database.

If the content database re-search reveals that the contents are still unregistered or unclassified, the acquired basic content information and the information acquired through the content analysis may be used to allocate a content classification code and then update the database.

Alternatively, if it is determined that the contents are registered, an opportunity may be given to update only the content database.

The database may be updated only when there is a change in data. In this situation, the record of previous information and the record of new information may be compared through a user interface and a correction may be made if necessary.

If the content registration process is to register general information of the contents, related information may be used to set desired information from the respective contents and correlate several contents.

For example, if book contents are present in an e-book, desired information may be extracted from the respective books and it may be stored in the database to enable cross reference.

For example, if a user has a question about a keyword or phrase in a book and designates it, not only related information of relevant book contents but also information about the relevant item from other books or multimedia contents may be searched and presented in an integrated manner, and a reference list may be created and presented if necessary.

The related information is to provide information related to items such as keywords, phrases, person names, place names, memo titles, tags, and time related to contents. A related information registration process may set items in indexes, keywords, person names, titles, subject words, tag information, memos, and additional information of contents, and may register additional information and location information in contents, indicated by the respective items, in the database.

For example, one book may include several keywords and concept descriptions thereof. In this situation, the keywords may correspond to items, a page describing the keywords may correspond to in-content location information, and reference data or memos related to the keywords may correspond to additional information.

TABLE 2

| | | contents | | | |
|---|---|---|---|---|---|
| | | classification | Offset/ | Data/Memo/Annotation/ | |
| | record | code | location | Attachment | Reference |
| 1 | Avatara | 291.13B [symbol] | page: 110; | http://db.samsung.com/c | Written by Arthur |
| | | 54 [symbol] 01 | line: 19-25; | heong/291.13B [symbol] 54 [symbol] | Cotterel, Kacci |
| | | | item: | 01/vishunu.html | GeulBang publish, |
| | | | [symbol] /Vishunu | | translated by Kacci |
| | | | | | editorial department/ |
| | | | | | A Dictionary of |
| | | | | | World Mythology, |
| | | | | | Kacci GeulBang/ |
| | | | | | Oxford University |
| | | | | | Press, 1996. 05. 20, |
| | | | | | page 110 |
| 2 | Avatar | 291.13IW01 | 320, 500; | circle: radious: 100; | Westend61/Getty |
| | | A01 | | color: 255,0,0; | Images, Avatar status |
| | | | | bgcolor: transparent; | in India, available in |
| | | | | | 2010, |
| | | | | | http://www.namsan.com/ |
| | | | | | hindu/india/avatar01.jpg |
| 3 | Avatara | 291.13Dwiki | | | Avatara, Wikipedia |
| | | 01 [symbol] 001 | | | Korean version, |
| | | | | | available in |
| | | | | | 2010.08.25: |
| | | | | | http://ko.wikipedia.org/wiki/%EC%95%84% |
| | | | | | EB%B0%94%ED%83%80%EB%9D%BC |
| 4 | Avatar | 813.5BS836S | page: xxx | | Neal Stephenson, |
| | | 01 | | | Snow Crash, Bantam |
| | | | | | spectra book, |
| | | | | | NewYork, 1992, pp. |
| | | | | | xxx; |
| 5 | Avatar | 688.2VC10A | seek: 540000 | http://db.samsung.com/ | James Cameron et al., |
| | | 01 | | cheong/688.2VC10A01.smi | Avatar, 20th Century |
| | | | | | Fox Home |
| | | | | | Entertainment, 2009, |
| | | | | | Duration 120 min., |
| | | | | | Blue-ray. |
| 6 | ColorCode | 535.05DC652 | | | Cheolho Cheong, |
| | | U01 | | | Gordon Bowman, |
| | | | | | Tack-Don Han, |
| | | | | | Unsupervised |
| | | | | | clustering approaches |
| | | | | | to color classification |
| | | | | | for color-based image |
| | | | | | code recognition, |
| | | | | | Applied Optics, vol. |
| | | | | | 47, iss. 3, pp: 2326-2345, |
| | | | | | 2008. 04. 28 |
| 7 | ColorCode | 535.05DC652 | Memo#3:\\myPC\journal\ | | Personal: |
| | | U01 | c.cheong2008_ucacccicr_Memo#3.ano. | | ColorCode, |
| | | | | | unpublished personal |
| | | | | | document, |
| | | | | | 2010.08.26: \\myPC\journal\c.- |
| | | | | | cheong2008_ucacccicr_Memo#3.ano. |
| 8 | ColorCode | 535.05VC01 | | | Personal: |
| | | C01 | | | C. Cheong, et al., |
| | | | | | ColorCode |
| | | | | | recognition: |
| | | | | | \\myPC\journal\c.cheong2008_ucacccicr.avi |
| 9 | ColorCode | 535.05CC01 | | | Personal: |
| | | C01 | | | C. Cheong, et al., |
| | | | | | ColorCode |
| | | | | | recognition: |
| | | | | | \\myPC\journal\c.cheong2008_ucacccicr.smi |

Table 2 shows an example where related information including items, content classification codes, in-content location information, and additional information are recorded in a database.

For example, an item #1 is registered for ‘avatara’ in a book of Arthur Corel or for a keyword ‘avatara’, which has a content classification code, in-content location information, and additional information.

Various information about a book in the database of Table 1, that is, content information may be provided through the content classification code of the item #1. Also, the in-content location information indicates that a relevant keyword is the content of lines 19-25 of a page #110 of a relevant book, and a related item, that is, the title of a chapter or a section is ‘Vishunu’.

Also, it additionally indicates that related additional information is present in a web site “http://db.samsung.com/cheong/291.13B [symbol] 54 [symbol] 01/vishunu.html”.

The in-content location information may be set in more detail, if necessary. For example, a sentence designating the location of a certain sentence or including certain keywords, and a phrase surrounded by certain keywords may also be possible. An item #2 relates to a keyword of ‘avatar’. Also, it relates to an image file designated by the code ‘291.13IW01A01’ in Table 1. The in-content location information indicates that a 320×500 pixel portion of a relevant image is designated, and the additional information indicates that a pixel having a radius of 100 around the relevant location represents ‘avatar’.

An item #5 indicates information about video contents. A portion related to a keyword ‘avatar’ indicates a 540,000 ms (i.e., 9 minutes 0 second) portion of a relevant video. In-content location information and additional information are not necessarily required in the related information registration process.

For example, as in the case of a web site where a certain keyword or phrase is a title or subject word like the item #3, only a content classification code may be registered.

The related information registration process may create and register items by using information of keywords, titles, subject words, tags, author names, publisher names, artist, and place names included in the content information, and then register other related information.

To this end, an apparatus according to an embodiment of the present disclosure sets basic content information (block 205). Thereafter, the apparatus searches a database for the contents (block 210).

If the contents are unregistered or unclassified (block 215), the apparatus determines the validity and the path of the contents (block 220). If the contents are analyzable (block 225), the apparatus sets content information (block 230). Thereafter, the apparatus re-searches the content database (block 235), and determines whether the contents are unregistered or unclassified (block 240).

If the contents are still unregistered or unclassified, the apparatus allocates a classification code to the contents (block 245). If a change is present therein (block 255), the apparatus stores the change in the content database (block 260).

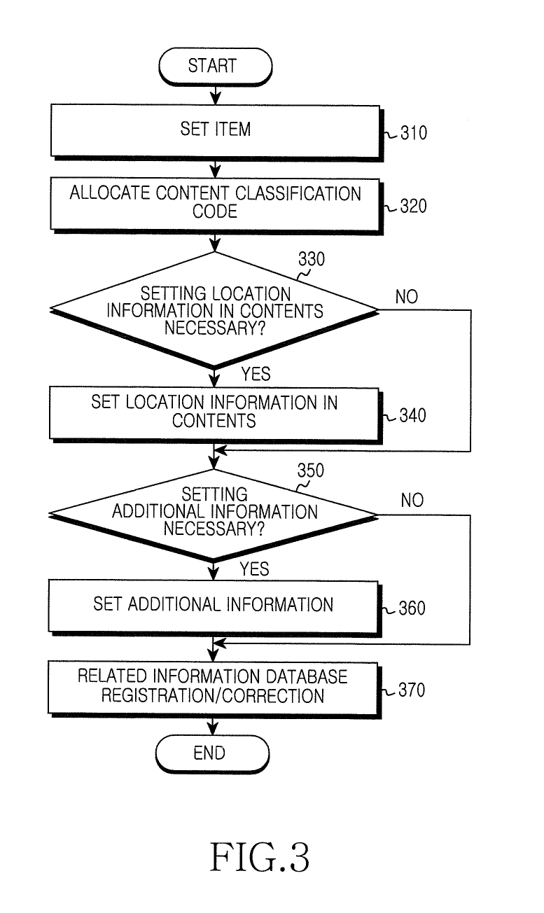

FIG. 3 is a flow diagram illustrating a process for registering related information according to an embodiment of the present disclosure.

Referring to FIG. 3, an apparatus according to an embodiment of the present disclosure sets an item for contents (block 310), and allocates a content classification code (block 320). If it is necessary to set location information in the contents (block 330), the apparatus sets the in-content location information (block 340).

Thereafter, if it is necessary to set additional information for the contents (block 350), the apparatus sets the additional information (block 360).

Thereafter, the apparatus registers or corrects the above information in a related information database (block 370).

The relation information registration process may be performed by searching the inside of contents and the entire region of the contents, or may be performed by a user interface during the content search. This may be selected according the user's convenience and necessity, and both of the two operations may be applied according to circumstances.

For example, if the content types are documents/books, and are structuralized and are constructed with a text, it is easy to search indexes, keywords, phrases, person names, titles, subject words, and tags with respect to the entire contents. Also, it is easy to detect the location in the corresponding contents.

In the case of caption contents in a music file format, it is easy to search and register related information such as keywords and time information. Therefore, when contents are registered, such operations may be performed on the entire content region.

However, there is a situation where this method is unsuitable. If relevant contents are documents of an image file format, all the pages of the contents are recognized by OCR prior to search in order to register all related contents. This may require very much time.

Also, if a certain portion is marked during the content search and related information operations such as addition/editing/deletion of memos or notes are performed on the relevant portion, it is necessary to register and correct related information thereof in real time.

In the case of a novel, a very large amount of unnecessary information is generated if all of the person names therein are registered as related information. Therefore, it is not preferable to search and register all the contents.

If an item of related information is not a single word but a phrase, it may be necessary to perform an edit operation by a user interface.

Thus, in these situations, it is preferable to create, edit and register related information with respect to person names, keywords, or phrases inputted or selected through a user interface.

Likewise, in the case of creating and registering related information with respect to a certain portion of a video or a certain portion of an image, it is preferable to register and edit a relevant item and other related information (e.g., time, location, and track information) by a user interface.

The creation and registration of related information may be performed by various methods. Embodiments thereof are as follows.

First, if contents mainly include texts such as documents, books, captions and lyrics, when a related information registration request is generated by registration, search and a user interface, a region corresponding to an index of relevant contents and a table of contents is searched and then relevant location information is registered together with the registered keywords and phrases.

For example, after keywords indicating a content table item and an index of a document (such as ‘index’, ‘contents’, ‘order’, ‘table or list’, and ‘title’) are searched, related information titles such as keywords, phrases, person names, place names, and terms included in the relevant item may be extracted, and in-content location information indicated by them may be searched and registered.

Similarly, in the case of a structuralized document such as an XML format, tags notifying such an item may be searched to register related information titles and in-content location information.

If a document is stored in an image file format, an OCR technique may be applied to the relevant regions so that it is recognized and registered. In this situation, a user interface may be provided for clearer storage.

Secondly, if items such as subject words and keywords are present in book or document contents, such subject words, keywords, or phrases are searched from a relevant document and they are registered together with a relevant sentence and portions including the sentence.

For example, because subject words or keywords are present in a thesis, they may be registered as the subject of the thesis by using these phrases. Also, if a portion corresponding to the relevant keyword is present in the text, location information such as a page number or a line number may be registered together.

Thirdly, in the case of book or document contents, information of references, footnotes, or endnotes mostly means other separate contents, not contents that are being determined. Also, according to circumstances, there may be contents that are newly searched and selected through the Internet.

For example, if a keyword or phrase with a reference number is selected from a thesis, new content information, that is, reference information may be acquired by the relevant reference number or a link connected thereto. Likewise, if a certain phrase is selected, specific contents may be searched through a web or database search function.

If new contents are found, there are two methods for processing the same. The first method is to draw a related information item from contents, which are being searched, and register a relevant reference item as additional information.

That is, a content classification code is maintained in a related information record as content information that is being searched, an item is designated, and a new record containing a relevant reference, a web site address, and content information is generated and registered in additional information.

At this point, in-content location information may also be recorded together. In this situation, a simpler phrase or keyword may be used as a related information item. If a sentence or paragraph is long, it may be additionally recorded or registered in an additional information field. Thereafter, if necessary, content registration and relation information registration may be additionally performed on new content information that is present in additional information.

The second method for creating and registering related information is to register new contents, which are found during the related information registration, in a content database by the above content registration method for more systematical management.

Thereafter, if necessary, with respect to the related information item, additional information and in-content location information are registered in a related information database together with a content classification code. Because there may be numerous references, a user interface may be provided to process only necessary references.

In the new content registration process, registration may be performed by the above content registration method.

In setting information of new contents, the reference itself usually contains content information such as a reference title, an author, a date, and a page. In this situation, basic content information is plentiful, and content registration determination is easier that that in general situations.

On the basis of content information, contents are acquired and content analysis is performed. The basic content information acquired is used to search a record of a content database, and it is compared with the existing information. Thereafter, content information, a content classification code, and a content path (if possible) are registered or corrected.

If it is difficult to allocate a content classification code because content information is insufficient, an unclassified classification code is temporarily allocated. Thereafter, a normal classification code may be allocated when relevant contents are acquired by means of downloading, accessing or copying.

In this situation, an unclassified code may be allocated using a category of a content classification number of detected new contents. For example, if a content classification code, which is being searched, is a category ‘291.13Bxxxxx’, an unclassified code may be allocated in a type ‘291.13Uyyyyy’. This is to preferentially prevent contents corresponding to a similar category when relevant information is searched later.

In another embodiment, the creation and registration of related information may be performed by various methods. The related information may be registered together during the search of book/document contents.

For example, if a user interface of the present disclosure is used to set a phrase of book contents on a block basis and a mark function is used to designate it and store the same together with a keyword, a relevant page and line information are registered together.

At this point, user input information such as memos or notes may also be recorded as additional information.

If the relevant contents are image files and the content type is a book/document, an OCR function for automatically extracting text contents from the image may be required.

Thus, in this situation, an OCR function is used to recognize a page number and selected characters. According to circumstances, a recognition range and an input type may be recognized through a user interface.

For example, if a target keyword is set by a mark/block on an image, a selection may be made to determine whether to register it as a title or a memo. Upon completion of the selection, an OCR function is used to automatically register a relevant block/mark portion in a relevant form.

Likewise, information such as a page number may be recognized by user mark/block settings. However, a relevant user interface may be provided so that a user may directly input relevant information without using a recognition function.

Fifthly, when multimedia contents are registered, specific location information and a phrase thereof are registered together during the search of the relevant contents.

For example, a pause operation is performed at a specific location of multimedia contents, such as music files, video files and flash files, and an interface for recording a keyword or phrase at a relevant point is provided to record relevant information.

That is, if a user stores a relevant play time and a keyword/phrase through a user interface at the start point of Movement 2 while listening to Beethoven's Symphony No. 5, and then searches the database for a phrase of Beethoven Symphony No. 5 Movement 2, the user may find a file corresponding to a relevant part or a track or time of a storage medium, seek a media file to a relevant time point, and play/enjoy the music.

In the case of an image file, a specific portion of an image is displayed by touch or mouse and a keyword or phrase is recorded in the relevant portion so that this can be used to easily search it.

For example, if such information is recorded in a Hercules image of each image file and it is searched from the database later, all the image files including the Hercules image may be found and a Hercules image portion may be displayed in each image file.

Multimedia information included in a web page or a specific application may also be registered in a similar way.

For example, if there is a video included in a specific web site, the web site may be registered as a document by the content registration method of the present disclosure. Also, in-content location information of the video may be registered using a video tag, its network address, and time information.

For the registration of related information, a candidate group may be presented through a user interface and the related information may be designated or corrected/edited prior to storage. According to circumstances, a function for adding additional information may be provided.

If a content classification code of the related information and the in-content location information are identical, it may be recorded as a similar word or a synonym.

For example, because ‘avatara’ and ‘ [symbol] ’ are synonyms in the item #1 of Table 2, they can be presented together in a later search if they are registered as similar words. They may be registered in a synonym database or may be registered together in a related information database.

When additional information is edited in a content information search, it may be considered together with in-content location information.

For example, item #7 of Table 2 shows a situation where a memo is added to thesis contents of item #6. That is, a relevant thesis has several memos, and a content classification code is used to indicate that the item #7 is the third memo and is allocated to the item #6. It indicates that the content of a relevant memo is recorded in a ‘\\myPC\journal\c.cheong2008_ucacccicr_Memo#3.ano’ file.

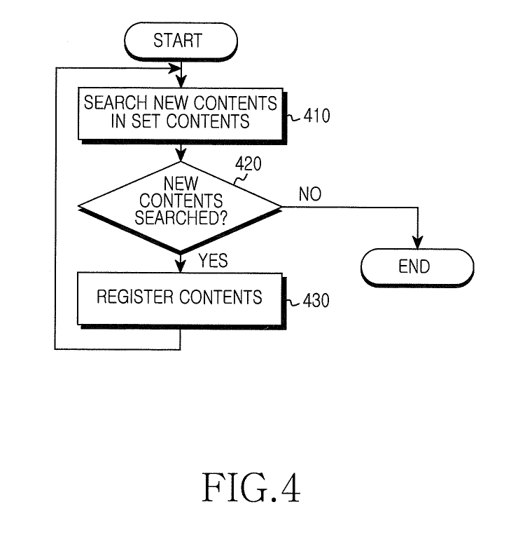

FIG. 4 is a flow diagram illustrating a process for registering new contents during the registration of related information according to an embodiment of the present disclosure.

Referring to FIG. 4, an apparatus according to an embodiment of the present disclosure searches new contents in set contents (block 410). Thereafter, if new contents are searched (block 420), the apparatus registers the searched contents (block 430).

If a related information item is inputted by a user interface, it may be necessary to search a related information database for the related information item and draw the corresponding content classification code, in-content location information, and additional information, for a related information determination in the present disclosure.

At this point, synonyms or words similar to the title of related information are determined and are simultaneously searched.

For example, if ‘avatar’ is searched in the database of Table 2, similar words such as ‘avatara’ are also searched.

This can be done by using a synonym dictionary database or by registering titles with the same in-content location information as similar words when creating the related information.

For example, if a word is recorded as ‘avatara’ in contents, it can be easily determined because it indicates that ‘avatara’ is the same word. Also, compound words or phrases including the related information title may also be searched together.

For example, if James Cameron's Avatar is present as the title of the related information database, it may be searched together when ‘avatar’ is inputted. The same is true for a simple search process, not a content determine process.

When the search is completed, the relevant records are arranged. If there are currently-determined contents, the most similar classification codes to its content classification code may be presented as a list.

For example, if the currently-determined contents have a classification code ‘291.13B’, they may be preferentially arranged in the order of ‘291.13B’, ‘291.13D’, ‘291.13I’, ‘291.13U’ and may then be arranged in the order of ‘688.2V’, ‘813.5B’.

In this situation, they are arranged from the contents of the most similar field, thus providing the related information most adjacent to the state of the currently-determined contents. Thus, they may be arranged in the order of information in the same contents, the same content classification codes, and similar contents.

The arrangement order may change according to the settings of the user interface.

For example, the content classification codes of related information may be classified according to content type or may be classified according to the similarity of content classification information. If the similarity of content classification codes has priority, contents more similar in code value than in content type may be first presented.

As an example, when there are a thesis and a caption file and a video file supporting the thesis, the thesis, caption file, and video file may be presented adjacently. Also, an arrangement according to the content type may be possible, such as an arrangement performed by grouping documents and grouping videos.

After the arrangement is completed, a process of presenting this through the user interface is performed. At this point, it may be presented using additional information and location information together after creation of a reference of related information.

For example, the title of relevant content information and author information may be displayed and selected from the list, and the content of additional information may be displayed by a pop-up window, a frame screen, or a balloon UI.

Also, relevant reference information may be separately stored, printed, transmitted, and copied with respect to the contents selected from the list. This function is very useful in performing a reference operation on a relevant keyword or phrase, particularly when creating a thesis or a report.

For example, if a user selects a certain portion through a user interface during the creation of a document to display a related information list, selects one or more references, and selects a reference addition in the user interface, a footnote, endnote or reference symbol may be set at the marked portion and a formatted reference list may be added in a footnote region, an endnote region or a desired region of the document that is being created.

For example, the formatted reference list may be displayed in accordance with an IEEE journal format or an IEEE conference manuscript format. Because the respective items are designated by the corresponding tags in the content information, they may be suitably created by changing the tag order, even when the reference format changes.

The reference information may be created by reflecting page information of the related information title, that is, the in-content location information, as shown in the item #1 of Table 2.

The relevant item shown in the reference field reflects the fact that it is present in page #110 of the relevant book. As another example, item #3 of Table 2 indicates information of a web site. In this situation, reference information is created by reflecting information about the determine time and date for the information of the web site.

This is to maintain an objective basis thereof by storing the internet content determine date, even when a copy of the web site is locally stored.

Thus, the content of the relevant web site may be determined during the creation of the reference information, and the content information and the related information database may be updated if a change is present therein.

Also, the content database itself may be searched, and other contents similar to the contents, which are being determined, may be recommended on the basis of the content classification code and the content information.

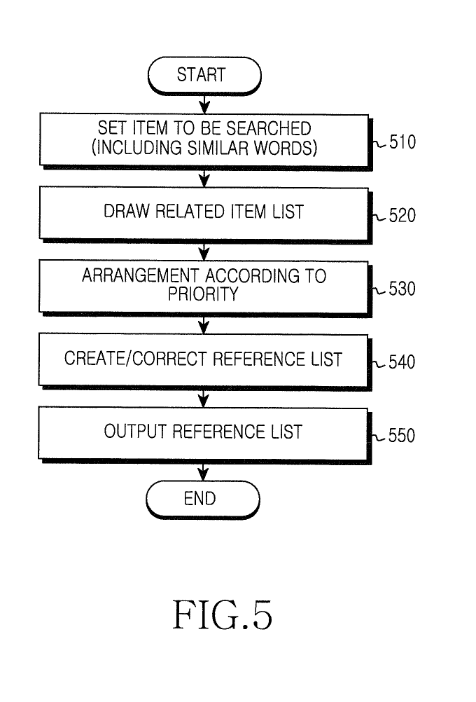

FIG. 5 is a flow diagram illustrating a process for determining related information according to an embodiment of the present disclosure.

Referring to FIG. 5, an apparatus according to an embodiment of the present disclosure sets a search item including similar words (block 510). Thereafter, the apparatus draws a list of related items (block 520), and arranges them according to priority (block 530).

Thereafter, the apparatus may create or correct a reference list (block 540), and displays the reference list (block 550).

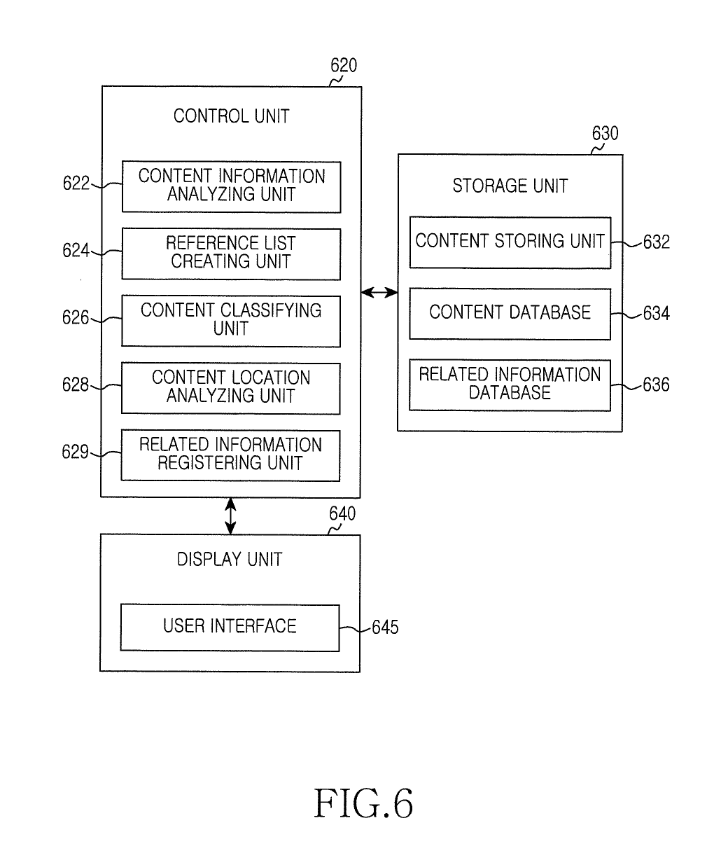

FIG. 6 is a block diagram of an apparatus according to an embodiment of the present disclosure.

Referring to FIG. 6, an apparatus according to an embodiment of the present disclosure may include a control unit 620, a storage unit 630, and a display unit 640.

The control unit 620 may include a content information analyzing unit 622, a reference list creating unit 624, a content classifying unit 626, a content location analyzing unit 628, and a related information registering unit 629.

The display unit 640 may include a user input unit 645 such as a touch panel.

The control unit 620 may control all the operations of the apparatus. That is, the control unit 620 may control the content information analyzing unit 622, the reference list creating unit 624, the content classifying unit 626, the content location analyzing unit 628, and the related information registering unit 629, and may perform a function of each unit.

The storage unit 630 may include information storage devices such as RAM, flash memory, ROM, and hard disk. The storage unit 630 may store data generated during the operation of the control unit 620.

The storage unit 630 may include a content storing unit 632, a content database 634, and a related information database 636.

The display unit 640 may include an LCD, an LED, a digital ink, a digital paper, a CRT, an AMOLED, and a 3D display. The display unit 640 may display picture information such as texts, videos, and images. The display unit 640 may display pixel control information generated by the control unit 620 according to screen attributes.

The content information analyzing unit 622 may extract content information and basic information from content-related searches, in-content information, and content-related information provided together with content names, content file names, and contents.

The reference list creating unit 624 may create a content list, and may perform reference list arrangement, selection, correction, and format designation according to requirements inputted from a user interface.

The content classifying unit 626 may analyze tag information of contents or may allocate a content classification code by using a classification code allocated to contents where related information is located.

The content location analyzing unit 628 may determine whether a relevant detailed content is included in a relevant content or attributes such as in-content locations and ranges are to be displayed in the determination of the relevant item, and may set the relevant content.

The related information registering unit 629 may set a tag of target information by using content titles, subject words, indexes, lists of contents, references, keywords, or phrases, for classification of related information.

The content storing unit 632 may store contents, may set a content path, and may determine whether the contents are actually present in setting the content path.

The content database 634 may include content information, content classification codes, or content path information. The content database 634 may provide a function for searching, registering, correcting, and determining the information. The content database 634 may provide a content database updating function for updating the content classification code in the content database 634. The content database 634 may perform a function for determining whether contents are unregistered or unclassified. Also, the content database 634 may determine whether contents are unregistered or unclassified, use the content information and the basic content information to redetermine the contents are unregistered or unclassified, and update the content classification code.

The related information database 636 may register or correct, if necessary, information constituting the related information record supporting the input/correction/determination of related information, additional information and in-content location information, may draw a related information list, and may arrange the related information according to priority by using the content classification code.

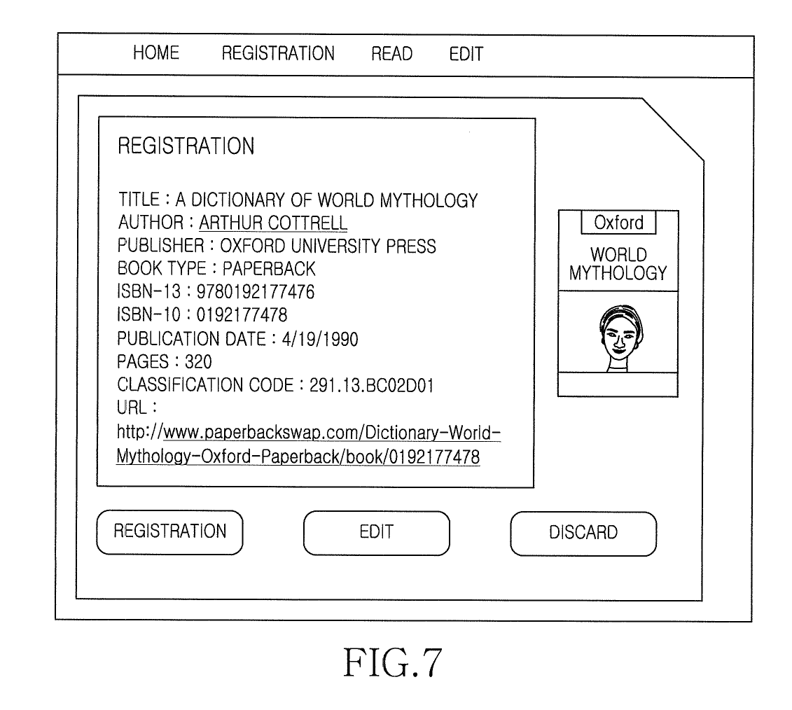

FIG. 7 is a diagram illustrating a content database registration process according to an embodiment of the present disclosure.

FIG. 7 illustrates a screen picture in an embodiment where a user determines or registers contents or a content information update request such as a content information correction request is generated. FIG. 7 illustrates an example where information about the contents is inputted or displayed for registration.

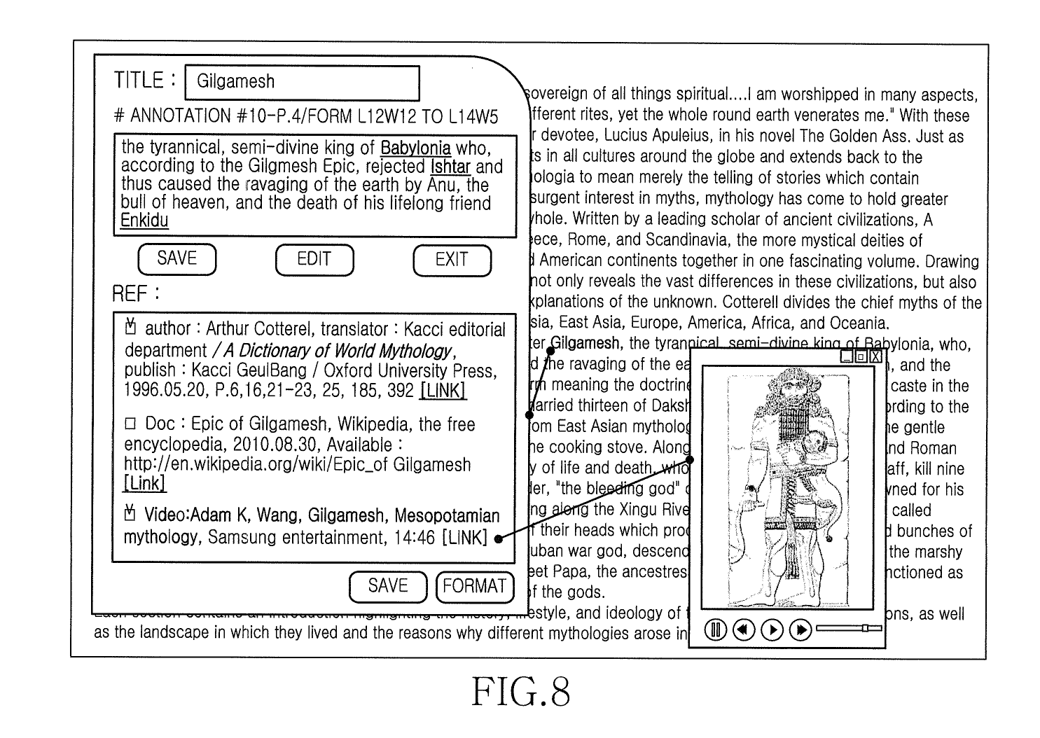

FIG. 8 is a diagram illustrating an example of related information input and reference information determination according to an embodiment of the present disclosure.

FIG. 8 shows an example where one user interface is used to provide related information input and reference information determination.

‘Gilgamesh’ is set as a related information item, and a phrase describing the item is selected. Then, it is automatically inputted to an additional information window, and in-content location information thereof is automatically set. The bottom of the relevant user interface shows reference information, which presents a book having a high correlation with ‘Gilgamesh’, web site information, and video file information.

The contents may be converted into a predetermined format through a reference format button, and a determine box button of the reference information may be used to select references that will be used or displayed later.

FIG. 8 shows an embodiment where a video reference among the reference information is selected to determine a video related to ‘Gilgamesh’ from a 14-minute 46-second portion of a video ‘Mesopotamian Mythology’.

The video file amounts to 32 minutes 58 seconds. A portion related to ‘Gilgamesh’ corresponds to a period from 14 minutes 46 seconds to 20 minutes 30 seconds, and it may be played during the period.

As described above, the present disclosure can systematically manage multimedia contents as well as book contents, and can provide cross references between the respective contents by similarity analysis. Thus, the present disclosure is very useful for fields such as e-libraries, e-books, document editors, and document viewers, and is applicable to various systems such as an electronic blackboard system and a mobile remote lecturing system.

The present disclosure performs classification based on content details in an e-book system, and manages the contents through the related information database. Therefore, the present disclosure can provide easy cross-references between contents, can present a more similar content list according to correlation when searching the contents, and can determine similar portions of other contents.

Also, the present disclosure can provide annotations such as memos and notes, can search and determine them together, and can preferentially present similar contents. Therefore, the present disclosure can manage not only annotations of certain contents but also other contents in an integrated manner, thus enabling users to maintain their extensive knowledge.

The present disclosure can be used to perform a search in an e-book system and to create a thesis and a report. The present disclosure can easily search and present a reference when using certain keywords or phrases. The present disclosure can convert such a list into a desired format and attach it to a document, thus providing easy operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for registering content information, comprising:
performing a content path setting process to set a path for an access to contents;
performing a content information setting process to acquire information related to the contents;
performing a content database searching process to search whether there is a database record similar to the information;
performing a content classification code setting process to set a content classification code for the contents if the search result is that the contents are not registered or are stored as an unclassified value; and
performing a content database updating process to update the content classification code in a content database.

2. The method of claim 1, wherein the content path setting process comprises determining whether the contents are actually present.

3. The method of claim 1, wherein the information related to the contents includes at least one of a content name, a file name of contents, content-related information provided together with the contents, information in the contents, additional information by a content-related search, and information acquired through a content information input by a user interface.

4. The method of claim 1, wherein the content database updating process comprises updating the content classification code for the contents in the content database if a change is present or the content classification code for the contents is absent in the content database.

5. A method for registering content information, comprising:
performing a basic content information setting process to set basic information of contents;
performing a content database determining process to determine whether the contents are unregistered or unclassified;
performing a content information setting process to set content information of the contents for content analysis if the contents are unregistered or unclassified;
performing a content database redetermining process to redetermine whether the contents are unregistered or unclassified, by redetermining a content database by using the content information and the basic content information;
performing a content classification code setting process to set a content classification code for the contents if the redetermination result is that the contents are unregistered or unclassified; and
performing a content database updating process to update the content classification code in the content database.

6. The method of claim 5, wherein the basic content information is acquired without parsing the contents.

7. The method of claim 5, wherein the content information setting process comprises:
determining whether an actual content path is valid, for content analysis; and
acquiring the content information if the actual content path is valid.

8. The method of claim 5, wherein the content database updating process comprises updating the content classification code for the contents in the content database if a change is present or the content classification code for the contents is absent in the content database.

9. A method for registering content-related information, comprising:
performing a related information item setting process to set items of related information for classification of the related information;
performing a content classification code setting process to set a content classification code by analyzing tag information of contents or by using a classification code allocated to contents where related information is located;
performing an in-content location information setting process to determine whether attributes including an in-content location and range are necessary for output when determining an item and content corresponding to the content classification code;
performing an additional information setting process to determine whether additional information is inputted by a user input and to set the additional information when the additional information is inputted; and
performing a related information updating process to update the related information if it is necessary to update information of a related information record.

10. The method of claim 9, wherein the in-content location information setting process comprises:
determining whether new contents are present at a content location set by a content database; and
registering the new contents if the new contents are present.

11. The method of claim 9, further comprising performing a user information inputting process to input information for classification of the related information to perform the related information item setting process.

12. The method of claim 11, wherein the user information inputting process comprises inputting a tag of desired information for classification of the related information by using title of contents, subject word, index, table of contents, reference, keyword, or phrase.

13. A method for determining content-related items, comprising:
performing a related information setting process to set content-related information to be searched;
performing a related information list drawing process to draw a related information list from a related information database;
performing a related information arranging process to arrange related information according to a predetermined priority by using a content classification code;
performing a reference list constructing process to construct a reference list by using the arranged related information, content information of a content database, and a user input; and
outputting the constructed reference list.

14. The method of claim 13, wherein the related information arranging process comprises selecting the predetermined priority through a user input.

15. The method of claim 13, further comprising outputting, in order to determine relevant contents, a relevant part of the relevant contents by using location information of the relevant contents, if a predetermined item is selected from the constructed reference list.

16. An apparatus for registering content information, comprising:
a content storing unit configured to set a path for an access to contents;
a content information analyzing unit configured to acquire information related to the contents;
a content database configured to search whether there is a database record similar to the information, and update a content classification code in a content database; and
a content classifying unit configured to set the content classification code if the search result is that the contents are not registered or are stored as an unclassified value.

17. The apparatus of claim 16, wherein to set the content path, the content storing unit determines whether the contents are actually present.

18. The apparatus of claim 16, wherein the information related to the contents includes at least one of a content name, a file name of contents, content-related information provided together with the contents, information in the contents, additional information by a content-related search, and information acquired through a content information input by a user interface.

19. The apparatus of claim 16, wherein to update the content database, the content database updates the content classification code for the contents in the content database if a change is present or the content classification code for the contents is absent in the content database.

20. An apparatus for registering content information, comprising:
a content information analyzing unit configured to set basic information of contents, and set content information of the contents for content analysis if the contents are unregistered or unclassified;
a content database configured to determine whether the contents are unregistered or unclassified, redetermine whether the contents are unregistered or unclassified by using the content information and the basic content information, and update a content classification code in the content database; and
a content classifying unit configured to set the content classification code for the contents if the redetermination result is that the contents are unregistered or unclassified.

21. The apparatus of claim 20, wherein the basic content information is acquired without parsing the contents.

22. The apparatus of claim 20, wherein to set the content information, the content information analyzing unit determines whether an actual content path is valid, for content analysis, and acquires the content information if the actual content path is valid.

23. The apparatus of claim 20, wherein to update the content database, the content database updates the content classification code for the contents in the content database if a change is present or the content classification code for the contents is absent in the content database.

24. An apparatus for registering content-related information, comprising:
a related information registering unit configured to set items of related information for classification of the related information;
a content classifying unit configured to set a content classification code by analyzing tag information of contents or by using a classification code allocated to contents where related information is located;
a content location analyzing unit configured to determine whether attributes including an in-content location and range are necessary for output when determining an item and content corresponding to the content classification code; and
a related information database configured to update the related information if it is necessary to update information of a related information record.

25. The apparatus of claim 24, wherein to set the in-content location information, the content location analyzing unit determines whether new contents are present at a content location set by a content database, and registers the new contents if the new contents are present.

26. The apparatus of claim 24, further comprising a user interface configured to determine whether additional information is inputted by a user input, and set the additional information when the additional information is inputted, in order to set the related information items.

27. The apparatus of claim 26, wherein by the user input, the user interface inputs a tag of desired information for classification of the related information by using title of contents, subject word, index, table of contents, reference, keyword, or phrase.

28. An apparatus for determining content-related items, comprising:
a user interface configured to set content-related information to be searched;
a related information database configured to draw a related information list, and arrange related information according to a predetermined priority by using a content classification code;
a reference list creating unit configured to construct a reference list by using the arranged related information, content information of a content database, and a user input; and
a display unit configured to output the constructed reference list.

29. The apparatus of claim 28, wherein to arrange the related information, the related information database selects the predetermined priority by a user input through the user interface.

30. The apparatus of claim 28, wherein to determine relevant contents, the display unit outputs a relevant part of the relevant contents by using location information of the relevant contents, if a predetermined item is selected from the constructed reference list.
